(19) United States
(12) Patent Application Publication
(10) Pub. No.: US 2002/0197381 A1
(43) Pub. Date: Dec. 26, 2002

(54) Caffeine complexes with enhanced taste, process for their preparation and their use

(76) Inventor: Andreas Burgard, Frankfurt am Main (DE)

Correspondence Address: ProPat, L.L.C., 2912 Crosby Road, Charlotte, NC, 28211-2815, US

(21) Appl. No.: 10/165,151

(22) Filed: Jun. 7, 2002

(30) Foreign Application Priority Data
Jun. 25, 2001 (DE) 101 30 505.2

(51) Int. Cl. A23L 1/236

(52) U.S. Cl. 426/602

(57) ABSTRACT

Complex compounds or adducts of caffeine and acesulfame in which caffeine and acesulfame are present in a molar ratio of 1:1 or 1:2 exhibit a pleasantly sweet taste and are suitable for numerous uses in caffeine-containing foods, drinks or pharmaceuticals. The compounds can be prepared from the dissolved components by simple reaction.

### BACKGROUND OF THE INVENTION

The present invention relates to complex compounds consisting of a sweetener and caffeine in which the bitter-taste of the caffeine is masked, a process for the preparation of such complexes, and their use.

Caffeine, a xanthine derivative, is present in numerous foods, for example coffee, tea, cola drinks, “energy drinks”, guarana and cocoa and the products made therefrom. Caffeine is, in addition, added to foods, for example yogurt, ice cream, or confectionery products, as additive because of its stimulatory action. Caffeine is completely absorbed and achieves its maximum level in the blood after 30 to 60 minutes. Caffeine passes shortly after absorption into the brain and there exhibits stimulatory action, which in adults can persist for several hours. In addition, caffeine promotes glycogenolysis and lipolysis, so that, in addition, more energy is provided to the body. In the fatigued people, the symptoms of fatigue are abolished and mental performance is increased (E. Hogervorst et al., Int. J. Sports Med. 1999, 20, 354-361).

However, caffeine has an unpleasant bitter taste, so that its use in foods and drinks, for example in a chewing gum, is often made very difficult, or special formulations are necessary for this.

Thus, for example, the US government in 1996 offered a research contract for developing a chewing gum containing caffeine. The background of this research contract was to find an alternative to coffee or cola drinks which can be consumed without any great effort in the event of sleep deficits in exceptional circumstances, for example military actions (Lynne Lamberg, Journal of the American Medical Association, Vol 281, 1999, 885-886).

Since June 1998, the US company Amurol Confections Co. has been offering the product Stay Alert, a chewing gum with the effect of a small cup of coffee per strip of this chewing gum. Stay Alert was approved in 1998 by the United States FDA and is offered in various flavors, such as mocha or peppermint flavor. In addition to caffeine, the sweetener acesulfame-K is also present in Stay Alert to enhance the taste. However, to produce such a chewing gum a premix of the individual components is required. Such mixtures of various components, however, frequently have the property that, during movements of such a mixture, for example during transport or in the metering system, because of the differing crystals or material properties of the individual components, separation can occur, which leads to, for example, a chewing gum having a relatively high caffeine content and little or no sweetener, and vice versa. Here, and in other applications, there is the problem of metering the components sweetener and caffeine as exactly as possible. Therefore, it would be desirable to be able to meter caffeine and sweetener in a defined ratio in a simple manner in which separation is no longer possible.

DE-A 1 242 622, EP-A 0 046 506, WO-A 99/04822 and WO-A 00/12067 describe compounds of sweetener and pharmaceuticals having an enhanced taste, in each case the sweetener and the active compound being present in a molar ratio of 1:1. These are acid addition salts or ionic salt compounds in which the sweetener molecule is present as anion. These are prepared by an acid-base reaction, the sweetener being reacted as an acid with the basic active compound.

It is an object of the present invention to provide caffeine in a form which enables its simple use and handling or metering in the production of, for example, foods, drinks or pharmaceuticals, and in which the bitter taste of caffeine is masked or suppressed.

### BRIEF DESCRIPTION OF THE INVENTION

Surprisingly, it has now been found that caffeine (formula II) can react with acesulfame-H (formula I), the acid corresponding to acesulfame-K, to give defined compounds. Acesulfame(6-methyl-3,4-dihydro-1,2,3-oxathiazin-4-one-2,2-dioxide) is a commercially available sweetener, especially in the form of the potassium salt (acesulfame-K). Both acesulfame-K and acesulfame-H, the acid corresponding to acesulfame-K, can be prepared by known processes (see DE-A 2453 063, Angew. Chemie 85, 965-973 (1973), EP-A 0 155 634). In the abovementioned reaction, not only are complexes in general successfully prepared from caffeine and acesulfame, but also defined compounds may be prepared from one molecule of caffeine and one or two molecules of acesulfame. The molar ratios of 1:1 and 1:2 of caffeine to acesulfame specified within these defined complexes have been confirmed by ¹H-NMR. These defined compounds are particularly preferred. In addition, the present invention also comprises the corresponding solvates of all complex compounds. Surprisingly, it has been established by X-ray structural analysis that these complexes of caffeine and acesulfame are not salts, which would really be expected from an acid-base reaction, but are nonionic caffeine-acesulfame adducts which are preferably in a molar ratio of 1:1 and 1:2. These caffeine-acesulfame adducts are therefore not salts, but are characterized by hydrogen bonds between one caffeine molecule and, for example, one or two acesulfame-H molecules. The acesulfame-H, according to X-ray structural analysis, is present in these adducts in its enol form.

The reaction diagram below serves to illustrate this fact:

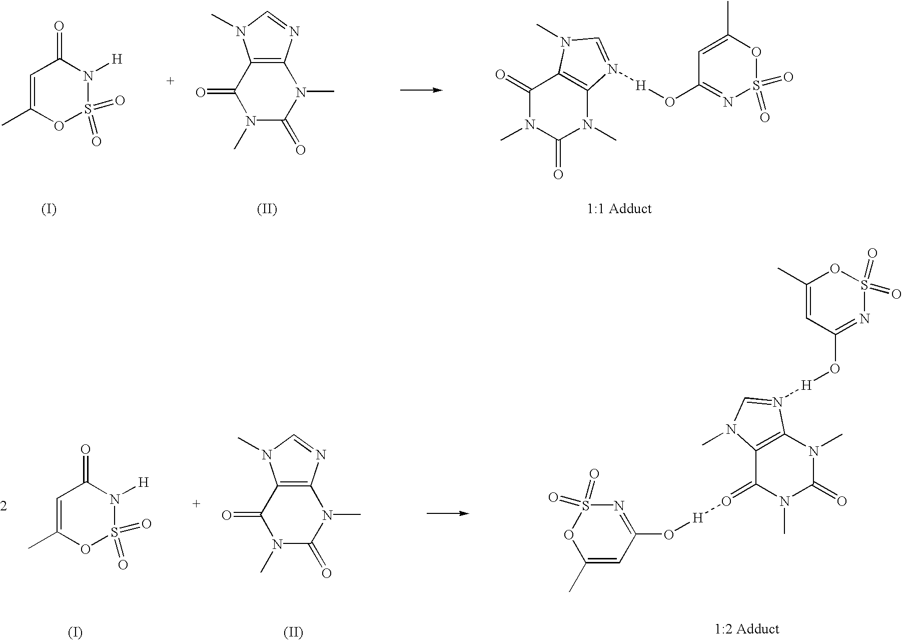

Surprisingly, all these compounds and their solvates are distinguished by a pleasant sweet taste, the unpleasant taste component of caffeine being markedly reduced in the 1:1 adduct, compared with caffeine without a sulfame, and in the 1:2 caffeine-acesulfame adduct being completely masked initially by a citrus-like sweet taste. The subsequent slightly bitter aftertaste of caffeine is very markedly reduced.

The adduct formation from caffeine and acesulfame, preferably in a defined ratio, leads not only to a reduction or masking of the unpleasantly bitter taste of caffeine, but the defined 1:1 or 1:2 caffeine-acesulfame adducts can then be incorporated into, for example, foods, drinks or pharmaceuticals, for example chewing gums, without the risk of separation. The problem of separation during transport or the metering operation likewise disappears.

Thus this also ensures that the end products thus prepared have the desired uniform and specified content of caffeine and sweetener.

Processing the inventive adducts in the food, drink or pharmaceutical industries, compared with adding caffeine alone or caffeine and sweetener as separate substances, requires no special measures, but is performed by the methods which are conventional there. This also applies in principle to pharmaceutical formulations which comprise these substances.

The present invention thus also comprises solid or liquid preparations, for example foods and drinks, for example in the form of chewing gum, tablets for chewing or compressed tablets, or else pharmaceuticals which comprise the inventive complexes or adducts and/or their solvates. In addition, the corresponding premixes which comprise these compounds and are used in the production of foods, drinks or pharmaceuticals, are comprised for the present invention.

The caffeine-sweetener or caffeine-acesulfame adducts are successfully synthesized very simply, for example from solutions, preferably from aqueous solutions or caffeine and acesulfame-H, in which the substances are preferably present in a molar ratio of 1:1 or 1:2. The resultant reaction solutions are freed from solvent in a suitable manner, for example in vacuo. In each case the corresponding caffeine-acesulfame adducts results as colorless crystals which, according to ¹H-NMR spectroscopy, occur in a molar ratio of 1:1 or 1:2 of caffeine-acesulfame. In this manner, the corresponding solvates can also be obtained.

The solvent or solvent mixture preferably used is water and/or water-miscible solvents, for example alcohols. The reaction temperatures are preferably 20 to 100° C., particularly preferably 30 to 70° C., very particularly preferably 40 to 60° C.

The examples below are intended to describe the invention in more detail.

### EXAMPLE 1

Preparation of a 1:1 Adduct of Caffeine and Acesulfame-H

4 mmol (0.785 g) of caffeine together with 4 mmol (0.653 g) of acesulfame-H are dissolved in 20 ml of water at 55° C. The reaction mixture is then concentrated in vacuo. Colorless crystals result at 100% yield, which, according to ¹H-NMR, are present as 1:1 adduct.

60-MHZ-¹H-NMR (D₂O): δ (ppm)=2.2 (s, 3H, CH₃-acesulfame), 3.35 (s, 3H, CH₃-caffeine), 3.52 (s, 3H, CH₃-caffeine), 4.02 (s, 3H, CH₃-caffeine) 5.95 (s, 1H, CH-acesulfame), 8.25 (s, 1H, CH-caffeine)

### EXAMPLE 2

Preparation of a 1:2 Adduct of Caffeine and Acesulfame-H

4 mmol (0.785 g) of caffeine together with 8 mmol (1.306 g) of acesulfame-H are dissolved in 20 ml of water at 55° C. The reaction mixture is then concentrated in vacuo. Colorless crystals result at 100% yield, which, according to ¹H-NMR, are present as 1:2 adduct.

60-MHz-¹H-NMR (D₂O): δ (ppm)=2.2 (s, 6H, CH₃-acesulfame), 3.35 (s, 3H, CH₃-caffeine), 3.52 (s, 3H, CH₃-caffeine), 4.02 (s, 3H, CH₃-caffeine) 5.95 (s, 2H, CH-acesulfame), 8.25 (s, 1H, CH-caffeine)

1. A compound of caffeine and acesulfame-H and its solvates.

2. A compound as claimed in claim 1, wherein the molar ratio of caffeine to acesulfame-H is 1:1 or 1:2.

3. A compound as claimed in claim 1, wherein it is a nonionic compound.

4. A solid or liquid preparation which comprises a compound as claimed in claim 1.

5. A preparation as claimed in claim 4, wherein it is a food, drink or pharmaceutical or a premix which can be used for its production.

6. A preparation as claimed in claim 4, wherein it is a chewing gum, a chewable tablet, or a compressed tablet.

7. A process for preparing a compound as claimed in claim 1 by reacting caffeine and acesulfame-H in the desired molar ratio in a suitable solvent or solvent mixture and, if appropriate, subsequent isolation of the reaction product formed.

8. The process as claimed in claim 7, wherein the solvent is water or water-miscible solvents or water and water miscible solvents.
